(19) United States
(12) Patent Application Publication
(10) Pub. No.: US 2006/0075088 A1
(43) Pub. Date: Apr. 6, 2006

(54) Method and System for Building a Client-Side Stateful Web Application

(76) Inventors: MING GUO, SAN JOSE, CA (US); YUXI SUN, FREMONT, CA (US)

Correspondence Address: MING GUO;YUXI SUN, 3397 CAVENDISH DR, SAN JOSE, CA, 95132, US

(21) Appl. No.: 10/711,565

(22) Filed: Sep. 24, 2004

(51) Int. Cl. G06F 15/173

(52) U.S. Cl. 709/224

(57) ABSTRACT

This is a method to keep user interaction states of a web application within a user agent, such as a web browser, by recording those states into a dynamically tagged tree structure, such as the document object model (DOM) structure, which resides in the user agent memory. Active current state is the collection of the tree nodes that are tagged active and rendered in the user agent. We also describe an embodiment of such method in the context of a system with server modules to systematically create and manipulate the client-side user agents' dynamically tagged state-recording tree structure.

### CROSS-REFERENCE TO THE RELATED APPLICATION

This application is entitled to the benefit of Provisional Patent Application Ser. No. 60/506,080, filed Sep. 24, 2003.

### FIELD OF THE INVENTION

The present invention relates to computer software, which is a method and system to store and manipulate user interaction states inside a user agent (usually a web browser)'s active memory as a specially tagged tree structure (such as a document object model, also know as DOM, structure).

### BACKGROUND—PRIOR ART ON STATE MANAGEMENT FOR WEB INTERACTIONS

World-Wide-Web is a revolutionary way of exchanging information between entities across broad geographical locations electronically. It also revolutionized the way traditional software applications are implemented: technical advances in client-server technologies give the rise to the so-called “web-applications”, software schemes utilizing the distribution of functional software features to clients without the need for end-users to actually install binary copies of such whole-piece software on their local computer, thus greatly improves security and productivity.

However, to fully utilize the promises of real “web-application”, a deficiency of the underlying network protocol for World-Wide-Web—HTTP (Hypertext Transmission Protocol)—must be addressed.

The deficiency lies in that: traditionally web interactions between the client-side user agent (commonly called “web browser”) and the server-side web service provider (commonly called “web server”), are viewed as discrete hopping sessions like that of browsing random pages in a book (hence the name “Hypertext”); meaning that the protocol can only keep track of one page at a time.

HTTP protocol is “stateless”, meaning that a current web “session” has no memory or knowledge of previous sessions (web pages). This usage scenario is quite different from a real software application whilst there are no discrete “sessions” during the interaction process and that every previous user input might have an impact of later interaction.

In a word, a software application, during its progressive interaction process, must keep states. To be able to realize real “web application”, schemes must be devised to address the need for “preserving states on top of a stateless HTTP protocol”.

Presently (other than the new mechanism to be described for this patent application) there are several mechanisms to preserve and serve state information between user and host (user agent and web server), to a limited extent:

(1) Initially user agent (“web browser”) vendors implemented extensions to support “cookies”, short text snippets embedded in HTTP headers, to keep state information on user's local computer. This mechanism is limited in usefulness due to the limited information it can carry across web sessions: it is mainly used to keep user preferences when visiting a previous web page. The most damning criticism toward this mechanism is that it stores information locally on user's local computer, often without the users consent, thus violates the user's privacy. Public outcry for this privacy intruding mechanism resulted in the widespread adoption of practice to disable the cookie feature in browsers, thus rendering the mechanism useless.

(2) Another mechanism is to embed a “session identifier” in one or more URLs (Universal Resource Locators) which appear in HTTP redirects, or server generated content descriptors (which amount to equivalent of a new web page), thus carrying state information from service (web server) to the user (user agent—“web browser”); and the state information can also be returned from user to the service when such URLs appear in an HTTP GET or POST request. This mechanism is better than that of the “cookie” mechanism described in (1): it does not compromise user privacy (no “cookie” files to be stored on a user's local computer). Yet it is still limited in its power because of the limited amount of state information it can carry in one direction, the service to user direction, in that only session identification information embedded in URLs can be transmitted, resulting in the limited knowledge of that service have on user sessions; as well as the limited “resolution” of user interaction it can utilize: only between new web pages, or it would result in frequent switching between too many small, fragmented web pages; which in reality is very difficult to maintain and implement; it also makes the use of such scheme extremely cumbersome and error-prone.

(3) Similar in extent to (2) is to use HTML forms to pass state information between the above said service and the above said user and back, without the user being aware of this happening. It too uses HTTP GET and POST messages to carry around the state information. Such mechanism bears similar limitations as that of (2). It must be addressed that (2) and (3) uses the original “bare” HTTP, without any added features of HTTP mentioned in (4) below.

(4) One immediate reaction to the “stateless” problem of HTTP is to amend the HTTP protocol to keep states between HTTP sessions. This has been done, resulting in RFC2965, dubbed “HTTP State Management Mechanism”. This proposal describes a way to create a stateful session with Hypertext Transfer Protocol (HTTP) requests and responses. It describes three new headers, Cookie, Cookie2, and Set-Cookie2, which carry state information between participating origin servers and user agents. The method described here differs from Netscape's Cookie proposal, but it can interoperate with HTTP/1.0 user agents that use Netscape's method. The purpose of HTTP State Management is to allow an HTTP-based service to create stateful “sessions” which persist across multiple HTTP transactions. A single session may involve transactions with multiple server hosts. Multiple client hosts may also be involved in a single session when the session data for a particular user is shared between client hosts (e.g., via a networked file system). In other words, the “session” retains state between a “user” and a “service”, not between particular hosts.

Whilst this mechanism does provide an increase in functionality over ordinary HTTP and HTML, it has serious drawbacks. First of all, this extension must be implemented in web servers and browsers in order for it to be widely adopt as a readily available method. Secondly, the method itself has some problems, best addressed in RFC2964 (Use of HTTP State Management). Among them the use of cookies, though different from extensions provided by browser vendors, still poses a security hazard. State information must be stored in an external “stable”, such as user's local computer hard disk, to be utilized in user/service interaction.

### SUMMARY OF PRIOR ART—SHORTCOMINGS OF ALL THE ABOVE STATE MANAGEMENT MECHANISMS IN VIEW OF A WEB APPLICATION

All the above mechanisms as a whole have the following characteristics in their state management techniques:

State information must be either
(1) Embedded in the network transmission channels (“session identifiers” embedded in URLs)
(2) Or stored on user's local computers as cookies
(3) Or returned as HTML forms

The first characteristic (1) requires that the server must predefine or pre-store all possible user interaction states. Since many a time this is impossible, limited states are provided. Thus results in a limited-fashion of a web application compared to their standalone software counterparts.

The second characteristic (2) actually has the potential to leak state information to third parties. Thus it is mainly a security concern. Of course functionally it is also very limited as stated in above sections. Using cookies is also quite unnatural, as it explicitly requires the extraction of state management information from the actual implementation of functional features.

The third characteristic (3) limits the kind of state information a web application can use and submit (only HTML forms). This also puts the burden of maintaining web application states on the shoulder of web application programmers, thus reducing their productivity on implementing functional features.

### PRESENT INVENTION—OBJECTS AND ADVANTAGES

Since version 4 of both major browsers, Netscape Communicator (hereby referred as “NC”) and Microsoft Internet Explorer (hereby referred as “IE”), have implemented features to enable the use of DHTML (Dynamic HTML), together with CSS (Cascading Style Sheets) and Javascript, web content authors can create more dynamic web contents using these new features. This trend culminated in the advent of the W3C DOM (Document Object Model) specification currently implemented since version 5+browsers (both NC and IE, NC is actually using the “Gecko” engine of the Mozilla project).

Accompanying the devising of DOM the major browser makers also implement features to remotely execute scripts on a web page to update portion of that page. The features and mechanisms are many and universal across all major browsers.

This patent application proposes an innovative way of utilizing the DOM to preserve unlimited and complex states in a web application, achieving the same level of granularity or beyond toward user interactions typically seen only in standalone GUI-enabled (Graphical User Interface) software applications.

In traditional web page based web applications, client-side state information is very crude and limited, usually in the form of various “cookies”. Users thus must depend on the server side to store and provide state-differed web pages. Subsequent web pages are sent to user depending on the submitted user “states” of previous browsed web pages, whether in the form of crude embedded “session identifiers” in URLs or HTML forms. In such schemes the server must be able to anticipate possible user browsing “paths” and providing subsequent web pages according to the “path” the user has chosen. Not surprisingly, a “path” is actually a possible “state” generated by the user interaction with previously said web page provided by said server. In simple “book” like content browsing or simple web pages providing simple functions, “paths” or “states” are not many and very limited in their order of appearance. However, in complicated web applications, there might be outstanding numbers of possible paths, making the server side programming extremely difficult, and sometimes, practically infeasible.

This reliance on web server to maintain user interaction states in web applications is not only burdensome and potentially making server the single point-of-failure but also unnecessary with the novelty solution rendered by our approach. Suppose that the user side, during the web application interaction, stores its own interactive states, and only subjugate a “final” path to the server when necessary. In traditional web pages, there is no room to accommodate such level of interaction, let alone store the vast amount of state information generated during user interaction. With the advent of DOM (Document Object Model) and devices accompanied to manipulate it, we hereby propose an innovative way to store web application interaction states: since DOM is implemented as a tree structure, we can alter this tree (augment, modify or reduce it, also in the mean while tag it) in regards to the growing or diminishing of user generated interaction states. State information is represented as tree leaves in the DOM per se, these leaves jointly formulate a current path in that DOM tree, and the current “path” is kept visible in the browser (corresponding tree nodes are tagged “active”) while other stored (not yet eliminated or pruned) “paths” are made invisible or off-focus (tagged as “inactive”). Our scheme systematically generates and categorizes any DOM leaf as either an “active” node or an “inactive” node and also alters such attribute (“active” or “inactive”) on the fly according to user interaction with the web application. User to server state information is collected and returned utilizing the DOM event model, thus surpassing the limited HTML form method.

In summary, our invention does not require server-side of the web application to keep any client-side user interaction states (the server however can choose to record client-side user interaction states for accounting or logging purpose). The user, on the client-side of the web application, can reach a vast amount of states that the server-side may have defined but never keeps track of. Or, most uniquely, our invention allows the possible scenario that the user creates its own new states dynamically in real-time that the server may never have knowledge or definition of. In a word, our invention enables the server to set no definitive limit on the number of states the client-side user interaction could have. In a sense, our invention switches the roles of client and server in a web application: in traditional web applications, the server has a dominant role, dictating the “legal” paths that the client must follow in order to get desired information; in the web application enabled by our invention, the client has a dominant role, it allows users to get information in ways themselves see fit; meanwhile, our approach does not maintain a persistent TCP session between server and client sides, on the contrary, the client is enabled with enough intelligence via DOM components manipulations and is able to re-initiate data transmission only when deemed necessary, moreover, duplicated or redundant data or web-page contents will not be transmitted as other client-server web applications.

Beside the advantage that it does not require the use of “cookies” or any new HTTP state management protocols, the present invention does not require downloading any application specific “plug-in” from the web application server, such as ActiveX controls for the Microsoft Internet Explorer user agent. “Plug-in” is actually disguised software application that runs inside a user agent. Its disadvantages are many, among them: violating the sandbox restriction of the user agent environment and requiring installation of third party components that many a time bring unknown risk of security hazard to the local computer.

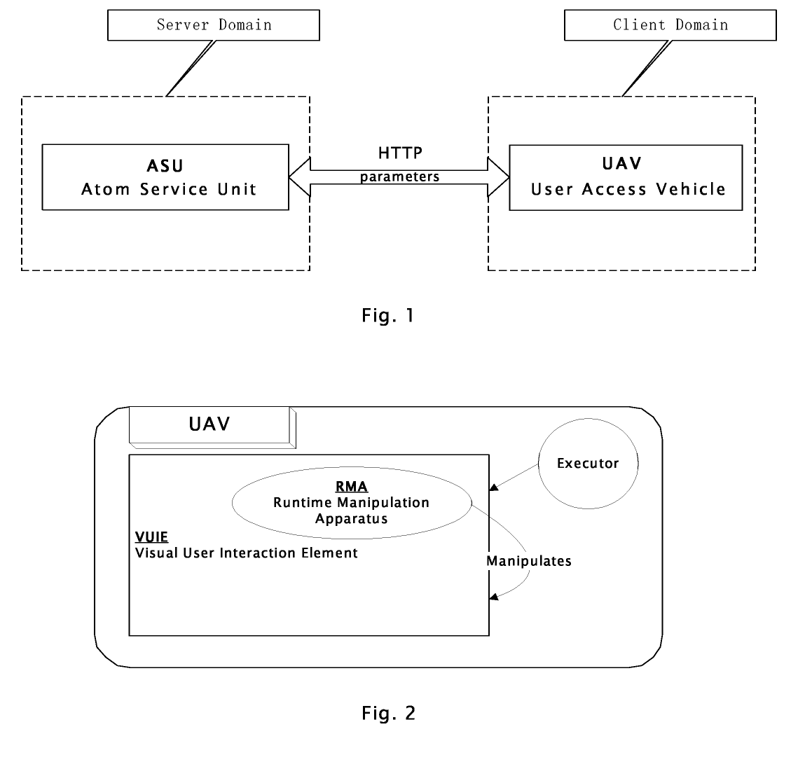

### PRESENT INVENTION—CONCEPTS—FIGS. 1, 2

To illustrate our method and system, we introduce the following terms:

Definition List 1

| Term | Definition |
|---|---|
| Atom | An indivisible data aggregate a service |
| | provides for its client |

All services provided by the web application server to its clients are data streams of various sizes; Atom is the smallest unit of these service data stream; anything the client receives that is less than the “Atom” unit should be seen as a service delivery failure.

For our method to work, Atom must comprise sub unit(s) of the following type(s):

Definition List 2

| Term | Definition |
|---|---|
| Executor | Instructions for the user agent (“web |
| | browser”) to alter its in-memory state |
| | tagged tree structure, such as the |
| | Document Object Model, DOM, tree |

An “Atom” must contain “Executor” as a sub unit. Without “Executor” the client-side user agent (“web browser”) would not be able to incorporate new information or state change into the existing in-memory Document Object Model (DOM) tree (or any other comparable tree structure).

Usually “Executor” is made of instructions of the user agent (“web browser”)'s own scripting language, such as Javascript.

Definition List 3

| Term | Definition |
|---|---|
| Inert | Non-instructional textual or markup |
| | data inside an “Atom” |

“Inert” means that these data are not instructions that the client-side user agent (“web browser”) could understand and execute to alter the in-memory DOM tree or comparable tree structure.

“Inert” is optional. Most of the time it's not a distinctive part beside “Executor”. Usually it is some textual (plain text) or markup (such as HTML, Hyper Text Markup Language) data inside “Executor” for appending or altering the client-side user agent's in-memory DOM tree or comparable tree structure. Sometimes “Executor” only changes the in-memory DOM tree's tags (like switching a tree node from an “active” state to an “inactive” state); in such case it's considered that “Inert” does not exist for the containing “Atom”.

Definition List 4

| Term | Definition |
|---|---|
| Runtime Manipulation | Special instructional data piece |
| Apparatus (RMA) | inside the markup data of “Inert” that |
| | could be launched by certain |
| | external event to manipulate the in- |
| | memory DOM tree or other |
| | comparable tree structure |

Markup data could be associated with the DOM tree or comparable tree structure (after user agent renders the markup data, for example). RMA, when associated with a DOM tree node, is an attribute (or “tag”) of said node that could be used by some external events (such as a mouse click by a user) to execute a piece of code (instructions such as in Javascript). RMA could even contain link(s) to ASU (Atom Service Unit, see definition below) to initiate transmission of new Atoms.

Usually RMA is in the form of registered event handlers within a DOM tree node. Such event handlers could be defined inside markup and later be transformed into DOM tree node attributes.

Definition List 5

| Term | Definition |
|---|---|
| Visual User | Markup data piece of “Inert” or |
| Interaction Element | instructional data of “Executor” that |
| (VUIE) | will be rendered as displayable screen |
| | elements that contains affiliated |
| | Runtime Manipulation Apparatus |
| | (RMA) |

VUIE corresponds to the markup data piece with RMA inside an Atom before user agent rendering those markup data. But more importantly, it refers to the rendered markup data in the form of visually accessible elements of a web page that contain RMA in the form of registered event handlers with executable instructions to manipulate the tagged DOM tree or comparable tree structure.

Visual User Interaction Elements are instrumental in the present invention as they are the access points in the tagged DOM tree or comparable tree structure that client-side users can initiate state changes.

Definition List 6

| Term | Definition |
|---|---|
| User Access Vehicle | The kind of Atom with Inert or |
| (UAV) | Executor in the form of VUIE with |
| | RMA |

User Access Vehicle (UAV) is the design element form of a web application to define where the user can initiate state changes. It fulfills the promise of the present invention that states are recorded into tagged DOM tree or comparable tree structure automatically and no state bookkeeping is necessary on the web application designers' part. UAV only concerns where state change can happen, not what states to keep track of.

Definition List 7

| Term | Definition |
|---|---|
| Atom Service Unit | The apparatus or code on the web |
| (ASU) | application server that emits an “Atom” |
| | to the client (user agent-“web browser”) |

Atom Service Unit (ASU) is the “producer” of service data for the service client. The output of an ASU is an Atom. The input of an ASU could be any data and could be quite complex. ASU generates UAV, a special Atom with elements on the client-side user agents that could initiate state changes.

### PRESENT INVENTION—THEORY OF USER INTERACTION STATE

The method of the present invention is to record state information into client-side user agent's in-memory tagged DOM tree or comparable tree structure in order to rid the web application designer's burden of bookkeeping states.

Therefore we shall now introduce the theory of “User Interaction State”:

In view of the concepts we brought up above, when computer users interact with web browsers, they in fact interact with Visual User Interaction Elements (VUIE as defined above). They could generate new states or initiate state changes because the Runtime Manipulation Apparatus (RMA, see definition above) could do things equivalent to state changes. Thus we could define “state” as a certain group of DOM tree nodes tagged with “state information”. The “state information” is just two tags equivalent to “active” or “inactive”. RMA generates new states or initiate state changes by
Creating new tagged nodes and appending them to the in-memory DOM tree or comparable tree structure or
Removing tagged nodes from the in-memory DOM tree or comparable tree structure or
Tagging nodes of the in-memory DOM tree or comparable tree structure.

Thus by the above operations we have recorded “state information” into the user agent (“web browser”)'s in-memory DOM tree or comparable tree structure.

### PRESENT INVENTION—CONCEPT DOMAIN CATEGORIZATION

In the problem domain that our method tries to address, we have data stream flows between two computer hosts: client and server. They can be categorized as the client domain and the server domain. The concepts we introduced earlier are categorized into these two domains according to whether the corresponding data entities will be executed or interpreted by the domain host environment:

Server Domain:

ASU (Atom Service Unit)—Executable functional code running on the server (web application server) to send data (Atom) to the client (user agent—“web browser”).

Client Domain:

Atom—Data client receives from server to be executed or interpreted on the client (user agent—“web browser”).

Executor—Code piece to be executed on the client (user agent—“web browser”).

Inert—Data to be rendered by the client (user agent—“web browser”).

RMA (Runtime Manipulation Apparatus)—Code piece to be executed on the client (user agent—“web browser”).

VUIE (Visual User Interaction Element)—Markup data or instructional scripts to be rendered by the client (user agent—“web browser”).

UAV (User Access Vehicle)—Data that can be executed or rendered by the client (user agent—“web browser”).

### PRESENT INVENTION—OPERATIONAL EMBODIMENT

With the aforementioned concepts, we could build a system for utilizing our method:

To design such a system, we should do the following:

Step 1:

Break up the functionalities of our service provider (web application) into service units—User Access Vehicles (UAV). A UAV is a kind of Atom that contains data (Executor and Inert) to install a distinct functional VUIE (Visual User Interaction Element) as part of the web application's visual presentation layer on the client-side user agent (“web browser”). VUIE also comes with RMA (Runtime Manipulation Apparatus) to provide user interaction capability for the web application's presentation layer.

An embodiment of the above step in a typical current computer setup can be describes as the following:

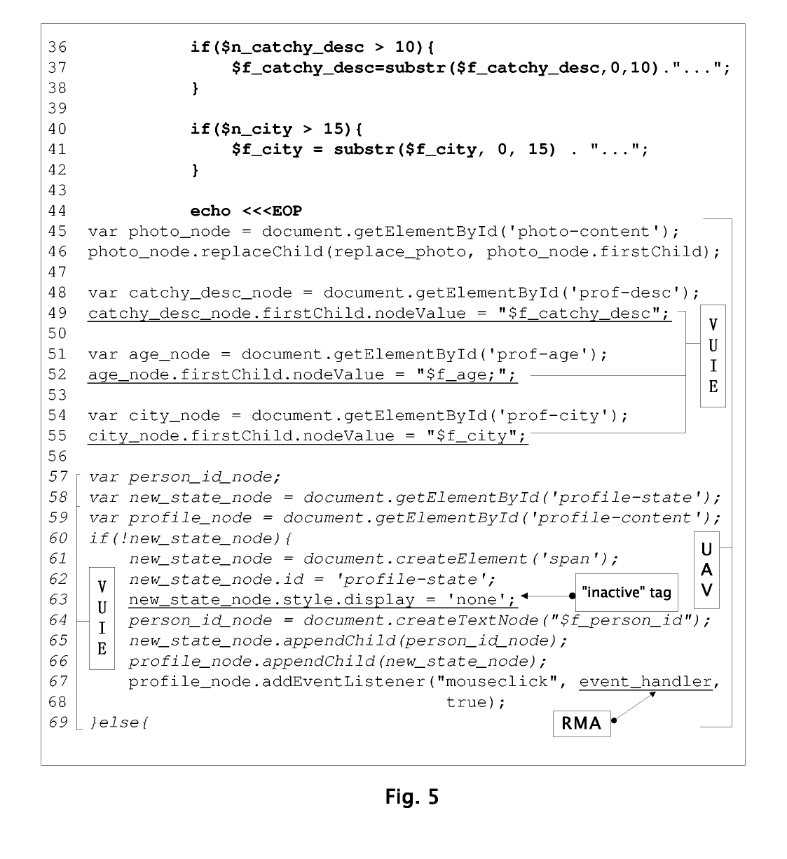

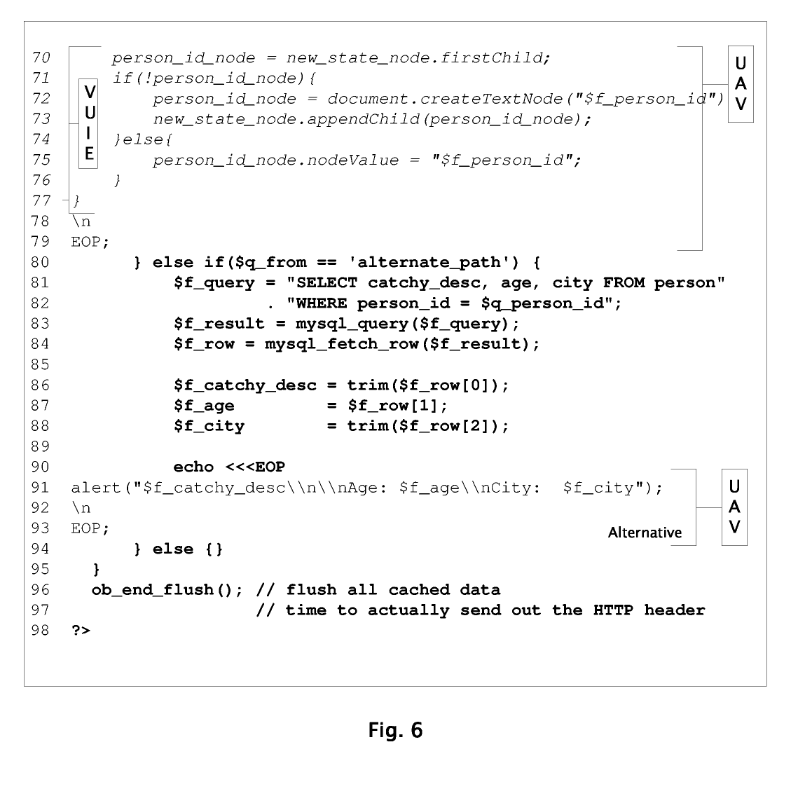

In current web browser environment, UAV is usually comprised of Javascript (Jscript in Microsoft Internet Explorer) code that can access and modify the web browser's in-memory DOM tree. VUIE is the markup code (sometimes embedded inside Javascript code) or Javascript code (as shown in our code example in FIG. 5 and FIG. 6) that can install visual elements part of the DOM tree, which are sometimes rendered from embedded markup data in the Javascript code (markup data are in the form of HTML or XHTML code, or XML code being rendered through XSLT). There are also Javascript codes that register event handlers with some of the DOM tree nodes rendered from markup data (event handlers can also be created by associating Javascript code with markup data elements). Such event handler Javascript code is what we called RMA (Runtime Manipulation Apparatus).

Step 2:

Implement RMA according to our “User Interaction State” theory discussed in the “theory” section.

Computer users of the web application create and change states at state change access points defined in VUIE of the previous step (Step 1). When user access a VUIE, an event is triggered by the user interaction (such as a mouse click, for example) that launches an event handler defined inside RMA associated with the corresponding VUIE. The embodiment of this step in a typical current computer setup is as the following:

The event handlerjavascript code does the following:
(1) Create new in-memory DOM tree node(s) and tag an attribute of said DOM tree node(s) as either “active” or “inactive”. Usually for DOM tree corresponds to HTML or XHTML markup, the attribute to tag is either “style.display” or “style.visibility”. For DOM tree corresponds to XML markup, the attribute to tag is custom-defined but should correspond to the above attribute of HTML or XHTML DOM tree if translated by XSLT later.
(2) Remove in-memory DOM tree node(s).
(3) Change an attribute of existing DOM tree node(s) as either “active” or “inactive” like that in (1).

Step 3:

Create ASU (Atom Service Unit) on the server to serve UAV (User Access Vehicle) to the client. An embodiment of this step in a typical current computer setup can be described as the following:

The current web application server breeds are many, among them the most popular ones can be described according to the server language they used: Java, PHP, Perl, ASP, etc. Whichever the web application is used, the fundamental embodiment of ASU is the same: ASU is one server executable program that can create a data stream that is the UAV and transfer it to the client-side user agent (“web browser”). The transmission is usually carried over the HTTP protocol. The server executable program is invoked from a web URL (Universal Resource Locator) or a link embedded inside a web page, or specifically, inside RMA of a VUIE as defined earlier. In the latter case, the ASU is a link embedded inside a piece of event handler Javascript code of RMA (Runtime Manipulation Apparatus).

ASU can be viewed as a function that produces UAV as its output. Such function, as any function, could be parameterized. This means that the output UAV is conditional upon certain parameters and that the output UAV might not be constant. The parameters could be categorized as either spatial (space-related) or temporal (time-related). Since ASU can be linked inside RMA, the parameterized ASU could be chained into many stages to perform very sophisticated state-change initiation. This feature obviously offers another dimension of the user interaction state manipulation capability of our method.

An embodiment scenario of such feature could be illustrated by the following example:

A web application service wants to provide two different screens to its users depending on the time user accesses the service URL; it also wants to treat users differently when coming from another associated web page URL link. To satisfy the above requirement a server program (ASU) could be authored to output two different UAV (encapsulating two different VUIE) to the client web browser based on two parameters: one is a string to identify request URLs which is a spatial (space) parameter; another one is a timestamp value to identify the time of the day which is a temporal (time) parameter.

### PRESENT INVENTION—DRAWING FIGURES

Drawing FIG. 1 shows the entity ASU (Atom Service Unit), UAV (User Access Vehicle) and there correspondent domains. It also shows the communication channel between the two entities-HTTP protocol. Parameters exist in the channel (in HTTP header) to affect how ASU outputs UAV.

Drawing FIG. 2 shows the entity relationships among UAV, VUIE (Visual User Interaction Element) and RMA (Runtime Manipulation Apparatus). UAV is a kind of Atom, it contains Executor and Inert; VUIE is a kind of Inert and RMA exists inside VUIE (attribute or property, which is in the form of event handler computer code registered within to-be-rendered DOM tree node inside VUIE).

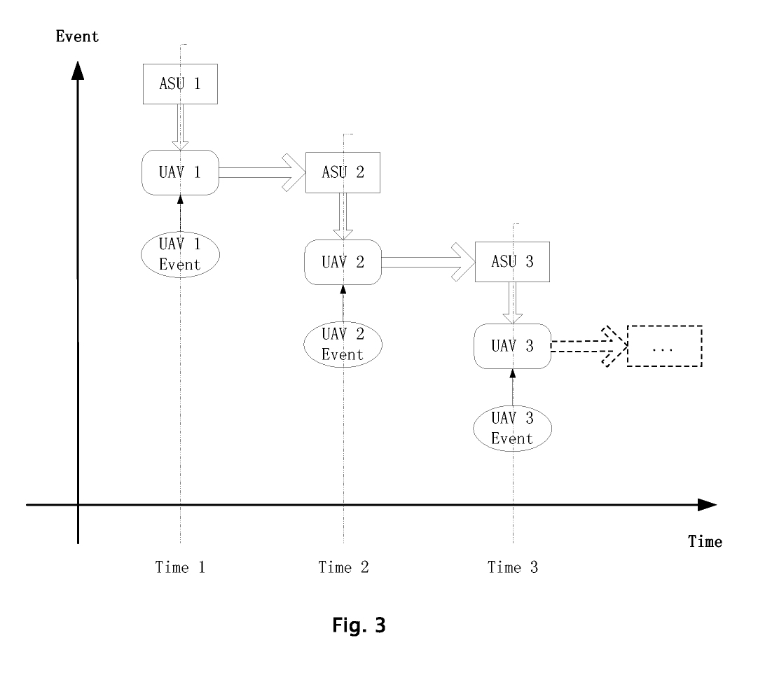

Drawing FIG. 3 using ASU-UAV symbol relationship as shown in FIG. 1, shows how event invoked from UAV triggers link to new ASU and generates new UAV, such that forms an event chain.

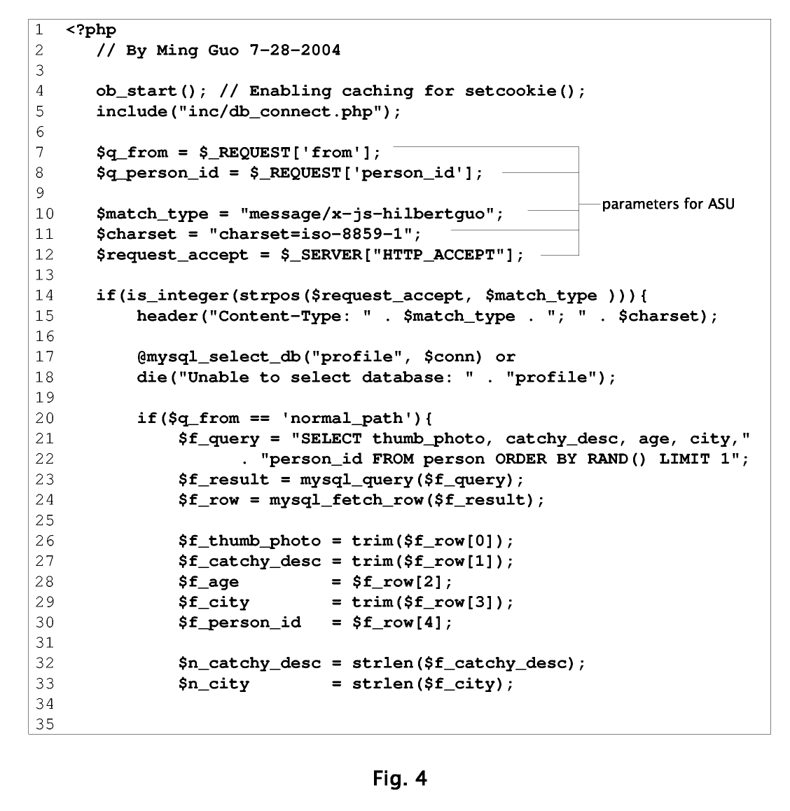

Drawing FIGS. 4, 5, 6 shows a code listing of a example embodiment of the present invention (line numbers are not part of the functional code):

This particular example embodiment program code runs on an Apache web server on a Unix host which executes PHP scripting language; it sends Javascript code to a user agent—web browser running the Mozilla “Gecko” engine. The code is for concept illustration (it is a functional program nonetheless), similar code can also be written for the Microsoft IIS web server using scripting language ASP and sending out Jscript code to the Internet Explorer browser, or other web application server with corresponding user agent.

The code is run on the Apache web server as a single executable program. The whole code constitutes an ASU (Atom Service Unit). The bold type-face lines—line 1 to line 44, line 80 to line 90, line 94 to line 98 are the ASU “engine”—functional body that generates UAV (User Access Vehicle, a kind of Atom) to the client-side user agent or web browser, which is written in PHP.

Light regular type-face lines—line 45 to line 79, line 91 to line 93 are UAV (User Access Vehicle) code in Javascript, which will be interpreted and executed once fully downloaded to a client-side user agent or web browser. Note that we show two instances of UAV in the code, the alternative UAV-line 91 to line 93 is sent out based on condition parameters in the ASU-line 7 to 12.

Code listing FIGS. 5, 6 shows various elements defined in the previous sections: VUIE (Visual User Interaction Element) and RMA (Runtime Manipulation Apparatus).

Line 63 of FIG. 5 also shows an “inactive” tag is attached to an attribute of a DOM tree node.

Line 91 to line 93 of FIG. 6 shows the alternative UAV generated by ASU—in this case they form a simple Atom with only one line of “Executor”.

Line 17 to line 24 of FIG. 4 and line 81 to line 84 of FIG. 6 query a database on the server side using SQL language; the database used in this embodiment example is MySQL database running on a Unix server.

The VUIE shown in FIG. 5 as line 57 to line 69 and in FIG. 6 as line 70 to 77 uses Javascript DOM API (Application Programming Interface) directly to render new visual elements, as compared to using embedded markup data (which uses the node.innerHTML property in HTML/XHTML DOM). Any of the above approach is an embodiment of VUIE and the merit of each is a programming nuance that should not concern our present invention.

### PRESENT INVENTION—SUMMARY

Thus we have shown a method to keep user interaction states by utilizing DOM tree nodes that tagged with state information. We also introduced a systematic approach to embody the said method.

What is claimed is:

1. A method for inducing new data to a web page at a client device, said method comprising: containing, at least one dynamically loaded and updated web page; manipulating, DOM (Document Object Model) components from within a web browser at the said client device in pursuant, but not limited to user input; apparatus for memorizing, recording the states of each web page into DOM; correlating, differences between different stages of each dynamic web page; enabling, operations on multiple said web pages parallelly.

2. A method for recording user interaction states on a user agent, which is a computer program, or web browser, such that an unlimited amount of said state information could be retained locally in the said user agent or web browser's volatile memory, without the need for the web application server, which is another computer program not necessarily residing on the same computer, to keep track of said state information in the said server's storage, by manipulating said user agent or web browser's in-memory Document Object Model tree or comparable tree structure, which is a rendered representation of data transmitted from said server, comprising any or a plurality of the following:
(a) creating new node tagged with attribute value equivalent to either “active” or “inactive” to said in-memory Document Object Model tree or comparable tree structure;
(b) removing existing node tagged with attribute value equivalent to either “active” or “inactive” from said in-memory Document Object Model tree or comparable tree structure;
(c) tagging existing node with attribute value equivalent to either “active” or “inactive” from said in-memory Document Object Model tree or comparable tree structure.

3. A method of constructing a computer software system utilizing the method of claim 2, which comprises the steps of:
(a) construct computer program instruction capable of being executed or interpreted by a user agent or web browser such that the execution or interpretation of the said instruction could result in the rendering of visual or textual data, which are transmitted from a web application server, on said user agent or web browser;
(b) construct computer program instruction capable of being executed or interpreted by a user agent or web browser that could perform manipulation of in-memory Document Object Model tree or comparable tree structure on said user agent or web browser, such as described in claim 2, and associate or register said computer program instruction with designated Document Object Model tree node that is rendered as visual presentation element that computer user could interaction with and thereby cause or initiate the execution or interpretation of said instruction on said user agent or web browser;
(c) construct computer program instruction that could be executed or interpreted on a web application server which generates output data in the form of computer program instruction such as (a) and (b) described in above steps and transmits them to user agent or web browser that requests said data.
